(19) United States
(12) Patent Application Publication
(10) Pub. No.: US 2009/0060473 A1
(43) Pub. Date: Mar. 5, 2009

(54) Portable Video Media Device Holder

(76) Inventors: Hans H. Kohte, Danville, CA (US); Marion R. Kohte, Danville, CA (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 12/136,691

(22) Filed: Jun. 10, 2008

Related U.S. Application Data
(60) Provisional application No. 60/970,019, filed on Sep. 5, 2007.

(51) Int. Cl. H04N 7/00

(52) U.S. Cl. 386/124

(57) ABSTRACT

The objective of the invention is the handsfree, comfortable viewing of iPhones or video iPods in virtually any location. The invention is a portable, flexible, soft aluminum rod that is adjustable to one's personal preferences, with two clamps, one at either end. One clamp is an adjustable holder that grips a video media player device and the other clamp is an anchor which can be attached to any solid surface or object.

### RELATED APPLICATIONS

This Application is related to U.S. Provisional Patent Application Ser. No. 60/970,019 filed Sep. 5, 2007 entitled PORTABLE GOOSENECK VIDEO IPOD HOLDER, which is incorporated herein by reference in its entirety, and claims any and all benefits to which it is entitled therefrom.

### FIELD OF THE INVENTION

This invention relates to a portable, temporary holding device for portable video media devices such as the iPhone®, and more particularly to a flexible shaft with a top and bottom clamp that holds iPhone or iPod® media players in a secure, steady and adjustable position for easy hands free video viewing and usage. (iPod and iPhone are registered trademarks of Apple Corporation.)

### BACKGROUND OF THE INVENTION

Media players such as the iPod® and the iPhone® are becoming increasingly popular in today's market with thousands of videos easily downloadable through the internet for rent or purchase. (iPod and iPhone are registered trademarks of Apple Corporation.) With iPod and iPhone owners usually holding their media player with their own hands for lengthy periods of time to view these videos, there is a need for a portable device holder that allows users to view video hands free, closer to one's face, and at the optimum viewing angle. The invention has several key features that specifically address those needs, two of which are unique.

First, there is no other portable holding device that can be mounted securely either upright or hanging down from any solid surface including uneven and round surfaces, such as an edged table ending, a round pole, or upside down from a car visor. The invention can be quickly, easily, and securely mounted as well as removed without any marks to one's video media player or the base surface. Although the invention is specifically designed to securely hold and view videos on one's iPod or iPhone, it can also hold many other media players and cell phones including but not limited to many Zune™ media players, PSP™, Treo® phones, BlackBerry® phones, etc. (Zune is a registered trademark of Microsoft Corporation, PSP is a registered trademark of Sony Computer Entertainment Inc., Treo is a registered trademark of Palm Inc., and Blackberry is a registered trademark of Research In Motion Limited)

The second unique feature of the invention is that it brings a media player up to eight full inches closer to one's face, giving the effect of a visibly larger screen surface, and it also positions the media player at the best viewing angle thanks to a ball and socket joint, thus providing a much improved overall viewing experience to the user. It is key to understand that with the exception of a user's own arm, no other portable device holder brings a media player similarly close to a user's face.

The other key features that make the invention of special value to users include the fact that the device is portable and hands free. When not in use, the shaft of the invention can be bent conveniently in such way as to take up a limited amount of space, thus making it convenient for travel. Although traditional device holders are also hands free, what makes this invention different is that it securely fastens to a variety of surfaces, either stable or unstable. For instance it can be attached to a tray table on a plane flying through turbulence, the rounded side of a hospital bed, the handles of a treadmill, the bars of a wheelchair, etc.

Traditionally there are holders which allow users to insert media players. Their primary function is to either electrically charge the media player, or to provide a speaker base for listening to music. Although some can be installed inside a moving vehicle, there are no dedicated portable media player holders that allow either an iPod or an iPhone to be positioned hands free at a specific viewing angle and none position the media player much closer to one's face.

There are a variety of different holders for electronic devices that have been created over the past years such as the following listing:

| | Patent/Publication No. | Title: |
|---|---|---|
| 1. | 20070045495A1 | Mobile Device Clamp Holder With Damped |
| | | Release Mechanism |
| 2. | 20060126824A1 | Electronic Device Holder |
| 3. | 20060126824A1 | Portable Electronic Device Clamp |
| 4. | 20040254002A1 | Clamping Device for Mobile Phones |
| 5. | 20020113185A1 | Holder For A Portable Electronic Device |
| 6. | 6366672 | Mobile Phone Holder |
| 7. | 6360083 | Clamping/Holding Device |
| 8. | 6085113 | Hand-free Holding Device For A Mobile |
| | | Telephone Set II |
| 9. | 5903645 | Clamping Device For Mobile Phones |
| 10. | 5836563 | Mobile Phone Holder |
| 11. | 5825874 | Mobile Telephone Holder |
| 12. | 5703946 | Mobile Phone Holder |
| 13. | 5697071 | Mobile Phone Holder Structure |
| 14. | 5555302 | Mobile telephone Holder |

U.S. Pat. No. 6,366,672 issued Apr. 4, 2002, entitled, MOBILE PHONE HOLDER, describes a clamping mechanism for mobile phones which attaches to power outlets found inside vehicles. However, the invention only allows for certain limited horizontal and vertical movement, whereas, the present invention allows for drastically better positioning of a media player. The prior art is designed specifically to attach to the power outlet of a vehicle, and has no means of securing to other surfaces, such as a lamp, a bedpost, a pole, an airplane tray table, etc. found in present invention.

U.S. Publication No. 20060126824A1 published Sep. 28, 2006, entitled, ELECTRONIC DEVICE HOLDER, describes a clamping mechanism for an electronic device which allows for easy access to the controls of an electronic device. The prior art also includes a flexible arm to support the device and allows the prior art to stand on a flat surface. The prior art, however, does not allow it to be affixed to non-flat surfaces. The present invention, uses a bottom clamp specifically designed to firmly attach to a variety of different objects or surfaces rather than be confined to flat surfaces like the prior art. In addition securely clamping onto surfaces also provides further stability of the holder itself as compared to a stand resting on a flat surface.

U.S. Publication No. 20070045495A1 published Mar. 1, 2007, entitled, MOBILE DEVICE CLAMP HOLDER WITH DAMPED RELEASE MECHANISM, describes a clamping mechanism for a portable electronic device where at least the first clamping jaw being displaceable toward the second clamping jaw to clamp the mobile electronic device. However, that invention does not include an elongated flexible shaft which allows for optimum positioning of the mobile device. The prior art also does not include a method for securing a clamp to a solid surface, such as a lamp, a bedpost, a pole, an airplane tray table, etc. as found in the present invention.

### ADVANTAGES AND SUMMARY OF THE INVENTION

The present invention is a holding device that allows for hands free viewing of several portable media players.

One object and advantage of the present invention is its portability providing the user with a hands free, comfortable viewing experience of an iPod or iPhone at virtually any time and in any place.

Another object and advantage of the present invention is to provide the user with a much improved viewing experience as the device adjusts an iPhone both horizontally and vertically with a ball and socket joint behind the back of a top clamp and positions such player up to eight full inches closer to one's face thanks to a flexible soft aluminum shaft.

Another object and advantage of the present invention is its ability to attach quickly, easily and securely to a variety of solid surfaces of different shapes such as a bed post, an airplane tray table, a vehicle's visors, etc.

Yet another object and advantage of the present invention is its ability to hold many different types of portable media playing devices and even some cell phones.

Yet another object and advantage of the present invention is that it has non-slipping surfaces on both top and bottom clamps to firmly and safely grip the media player device as well as the base surface itself to prevent scratching and movement when in use.

Yet another object and advantage of the present invention is its portable size and foldable structure that makes for easy travel inside someone's pocket, handbag, backpack, briefcase or luggage when traveling.

Further details, objects and advantages of the present invention will become apparent through the following descriptions, and will be included and incorporated herein.

The present invention relates to a portable extended flexible shaft with two unique clamps at each end; the top clamp is designed to securely grip an iPhone or video iPod and the bottom clamp is designed for a solid surface base. The flexible shaft can be adjusted to obtain a preferred viewing angle and distance to watch video on a device's screen. The present invention consists essentially of the following components: One covered flexible soft aluminum shaft; Two unique clamps, one on each end. Each clamp is lined with a non-slip surface material to protect the media player as well as the mounting surface itself.

### BRIEF DESCRIPTION OF THE DRAWINGS

FIG. 1 is a representative isometric view of an embodiment of the portable video media device holder 100 of the present invention.

FIG. 2 is a side section view of an embodiment of the portable video media device holder 100 of the present invention.

FIG. 3A is an exploded view of an embodiment of adjustable top device clamp portion 300 of the portable video media device holder 100 of the present invention.

FIG. 3B is an exploded view of an embodiment of anchor clip portion 400 of the portable video media device holder 100 of the present invention.

FIG. 4 is a representative illustration showing a method of use of the portable video media device holder 100 of the present invention.

FIG. 5 is a representative isometric view of an alternative embodiment of telescoping extender 500 of the portable video media device holder 100′ of the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

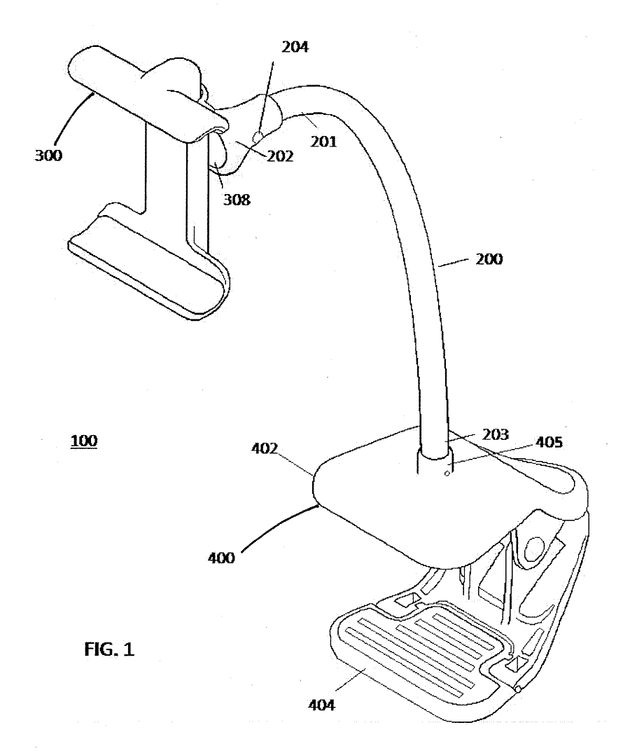

FIG. 1 is a representative isometric view of an embodiment of the portable video media device holder 100 of the present invention. As shown in FIG. 1, the portable video media device holder 100 of the present invention consists essentially of adjustable device clamp portion 300, flexible shaft 200 and anchor clip portion 400. In one embodiment, the flexible shaft 200 is an elongated tube like structure that allows somewhat elastic, temporary bending with reasonably minimum effort. To achieve this essential property, the flexible shaft 200 is made of flexible but strong materials such as aluminum wire with a protective cover. In one alternative embodiment, flexible shaft 200 has a personalized tubular protective cover 212 (not shown) which can be optionally installed to encase flexible shaft 200 partly or entirely to increase appeal and add extra protection for flexible shaft 200. In combination with ball joint 308, flexible shaft 200 allows for freedom of positioning of the iPhone device 90 to optimize viewing distance and angle for one viewer or more. Moreover, flexible shaft 200 enables folding of the present invention 100 into a more compact state or configuration for storage or travel purposes.

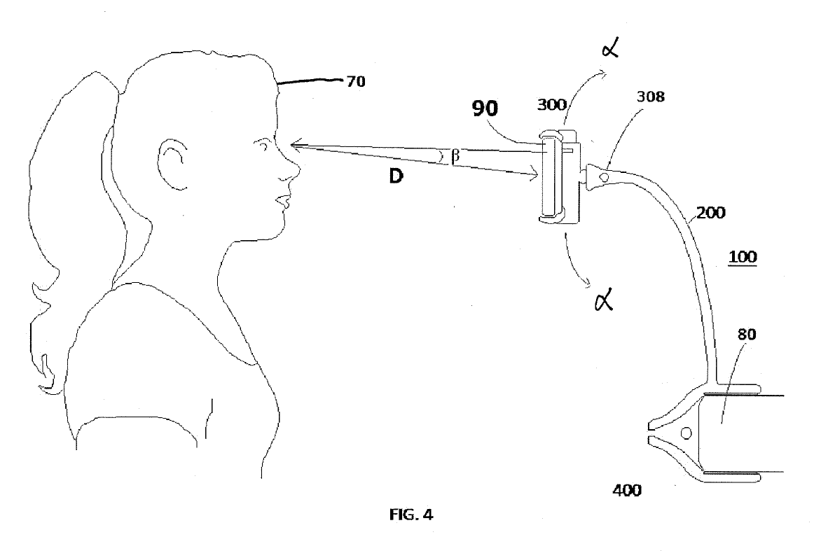

As shown in FIG. 1, the elongated flexible shaft 200 has two ends, namely, proximal end 201 and distal end 203. In one embodiment, proximal end 201 is coupled to the adjustable clamp portion 300 by ball joint 308. The purpose of adjustable clamp portion 300 is to hold the iPhone 90 which can come in a variety of sizes and shapes. Due to the combination of ball joint 308 and flexible shaft 200, user 70 can easily adjust viewing distance D and angle β (see FIG. 4).

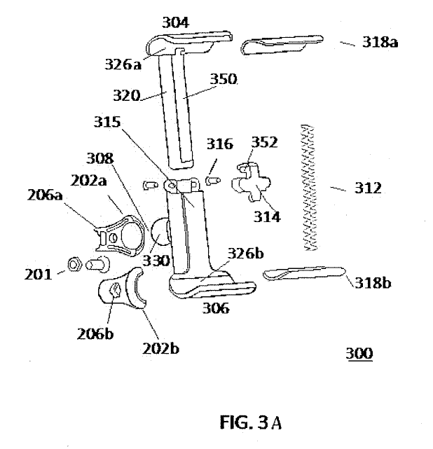

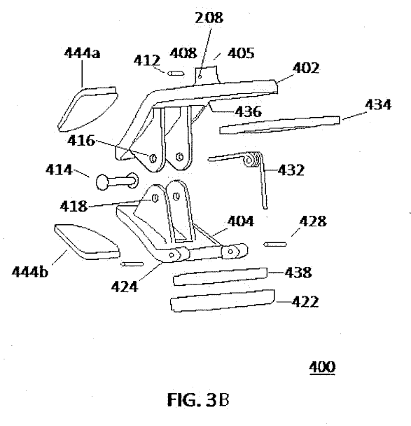

As shown in FIG. 1, distal end 203 of the flexible shaft 200 is coupled firmly at housing 405 on anchor clip portion 400 by mechanical means. The distal end 203 of the elongated flexible shaft 200 is rigidly coupled to anchor clip 400 which further comprises top clamping jaw 402 and bottom clamping jaw 404. In one embodiment, the key function of anchor clamp 400 is to secure a temporary but stable position of the entire portable video media device holder 100 on any solid surface so as to allow viewing of the iPhone device 90 virtually anywhere. As best shown in FIG. 1 and FIG. 3B, anchor clip 400 can take the form of, but not limited to, a spring clip.

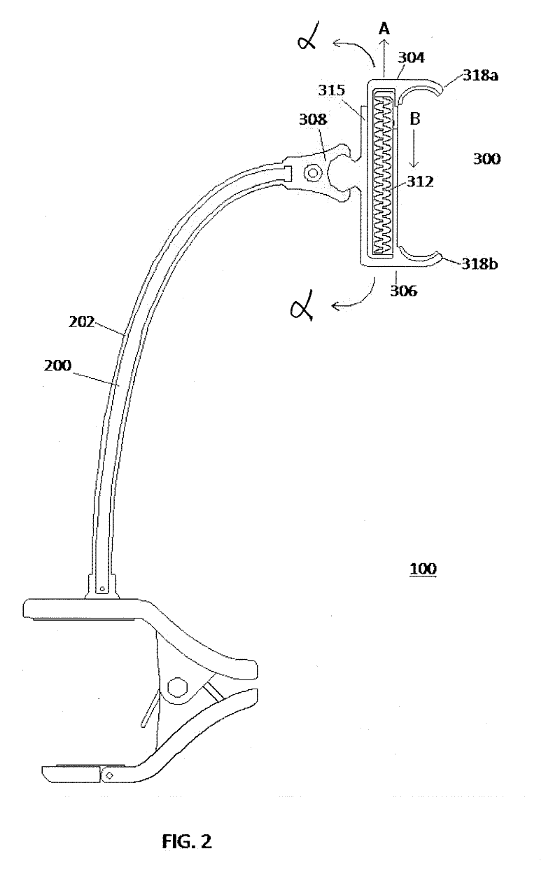

FIG. 2 is a side section view of an embodiment of the portable video media device holder 100 of the present invention. As shown in FIG. 2, the coupling between the ball joint 308 allows a 360 degree movement and elongated flexible shaft 200 allows for additional positioning freedom by allowing the iPhone device 90, when clamped into place, to be tilted both upwards and downwards. The ball joint 308 also allows for side to side tilting α of the iPhone device.

As shown in FIG. 2, adjustable clamp 300 is a spring operated clamp which enables firm grip on small apparatus and articles such as iPhones®, iPods®, PSP®, Zune®, and many other portable media players of similar consumer electronics-size and shape. In one embodiment, adjustable clamp 300 consists mainly of rigid clamping jaw 306, adjustable clamping jaw 304 and one spring 312 which nested inside housing 315 of rigid clamping jaw 306. In one embodiment, both clamping jaws 304 and 306 have a curved inside edge which when used together will secure the gripping position of iPhone device 90. As shown in FIG. 2 and FIG. 3A, curved inside edge of jaw ends 304 and 306 both have a gripping pad 318a and 318b affixed. The gripping pads 318a and 318b, are made of materials that are soft, non-slippery, with high scratch resistance such as silicon rubber, plastic, leather etc., which act to firmly grip the video media player device 90 while also preventing scratches to the edges of the iPhone device 90 to be gripped. In one embodiment, spring 312 is compressed by default so that when adjustable clamping jaw 304 is pulled in direction A to open up the entire adjustable clamp 300, it provides a constant pull in direction B so as to provide a firm grip of the iPhone 90.

As shown in FIG. 2, flexible shaft 200 is wrapped completely by tubular protective coating 202 to provide additional protection and support to flexible shaft 200.

FIG. 3A is an exploded view of an embodiment of adjustable device clamp portion 300 of the portable video media device holder 100 of the present invention. As shown in FIG. 3A, rigid clamping jaw 306 takes an L-shape having a hollow jaw body housing 315 attached integrally to a horizontal jaw end 326b at the closing end. In one embodiment, adjustable clamping jaw 304 also takes an L-shape which consists of a solid jaw body 320 and a horizontal jaw end 326a attached integrally at its end. In one embodiment, the cross-sectional shape of jaw body 320 of adjustable clamping jaw 304 should be corresponding to the cross-sectional shape of jaw body housing 315 of rigid clamping jaw 306 so that jaw body 320 can be inserted inside jaw body housing 315. In one embodiment, jaw body 320 has spring groove 350 running through its entire length to accommodate spring 312. As shown in FIG. 2 and FIG. 3A, jaw ends 326 of both rigid clamping jaw 306 and adjustable clamping jaw 304 have a curved inside surface to secure the gripped position of iPhone 90 (not shown). In one embodiment, gripping pads 318a and 318b are affixed on the curved inside surfaces of jaw ends 326a and 326b. The gripping pads 318a and 318b, are made of materials that are soft, non-slippery, with high scratch resistance such as silicon rubber, plastic, leather etc., which acts to firmly grip the iPhone 90 (not shown) while also preventing scratches to the surfaces of the iPhone 90 (not shown). Jaw body 320 of adjustable clamping jaw 304 is inserted inside jaw body housing 315 of rigid clamping jaw 306, it should be able to slide freely. During assembly, spring 312 is placed in spring groove 350 and the entire jaw body 320 is inserted inside jaw body housing 315. In one embodiment, rigid clamping jaw 306 and adjustable clamping jaw 304 are held in place by a back plate 314. In one embodiment, back plate 314 is bound by a mechanical coupling means, such as screws, glue, other adhesive or mechanical coupling system, to rigid clamping jaw 306. A pair of screws 316 fit into the screw holes in the rigid clamping jaw 306. As shown in FIG. 3A, back plate 314 has stopper 352 on one end. Stopper 352 is inserted at the top of adjustable clamping jaw 306 on the opposite end of jaw end 326b to prevent jaw body 320 and spring 312 from sliding off from jaw body housing 315 entirely. In one embodiment, spring 312 should be slightly compressed so it will provide a constant pull on adjustable clamping jaw 304 towards rigid clamping jaw 306 so as to provide a constant grip on iPhone 90 (not shown).

As shown in FIG. 3A, ball joint 308 consists essentially of ball 330 and two symmetrical socket halves 202a and 202b. Ball 330 is attached integrally at the back of jaw body housing 315 of rigid clamping jaw 306. Ball joint 308 is coupled mechanically to the proximal end 201 of flexible shaft 200 at one end. The two symmetrical socket halves 202a and 202b are secured by mechanical means, in this case, a screw 204 binds the two halves 202a and 202b by locking into a screw hole 206a and 206b as best shown in FIG. 3A. In one embodiment, when assembled, two symmetrical socket halves 202a and 202b will form a socket housing 308 corresponding to ball 330 and together they will function as a regular ball-and-socket joint which allows for 360 degree rotations of the entire adjustable device clamp portion 300.

FIG. 3B is an exploded view of an embodiment of anchor clip portion 400 of the portable video media device holder 100 of the present invention. As best shown in FIG. 1 and FIG. 3B, anchor clip portion 400 takes the form of a regular spring clip the main function of which is to clip on any solid surface to anchor the entire portable video media device holder 100. In one embodiment, upper clamping jaw 402 has neck housing 405 located on the top side to house the distal end 203 of the elongated flexible shaft 200 and upper clamping plate 434 attached. Lower jaw 404 has two lower clamping plates 438 and 422 all coupled on a hinge to allow mutual rotational movement. In one embodiment, distal end 203 of flexible shaft 200 can be anchored inside shaft housing 405 by mechanical means such as the locking pin hole 208 on distal end 203 and locking pin 412 system or other means such as adhesives. In one embodiment, upper clamping jaw 402 and lower jaw 404 are coupled together by bolt 414 which fits in the bolt hole 416 of upper clamping jaw 402 and bolt hole 418 of lower jaw 404. As shown in FIG. 3B, the top surfaces of both upper clamping jaw 402 and lower clamping jaw 404 can be lined by non-slip pads 444a and 444b to avoid slipping of user's fingers while applying force on anchor clip portion 400. In one embodiment, bolt 414 is wrapped by spring coil 432 which provides constant resistance when upper jaw 402 and lower jaw 404 are opened. In so doing, when force is exerted on the end of the upper jaw 402 and lower jaw 404, the entire anchor clip portion 400 will open and allows the anchor clamp 400 to clip onto a surface such as a table. When the force is released, anchor clamp portion 400 will close on the intended surface to grip by the top clamping jaw 402 and clamping plate 422. The underside of upper clamping plate 402 and lower clamping plate 422 are both lined with gripping pads 434 and 438 which could be made of any non-slip material for gripping purposes. Since bottom clamping plate 422 is coupled to its respective clamping jaw 404 with gripping pad 438 by hinges, when anchor clip portion 400 is closed by spring coil 432, mutual rotational movement will happen at all connecting hinges such that gripping pads 438 and 434 are both in the closest contact with the gripping surface (not shown). Since lower jaw 404 has clamping plate 422 with gripping pad 438 attached by a hinge, it will allow anchor clip portion 400 to grip on most surfaces including round, irregular shapes etc. Thus, the present invention 100 can be used to clamp to round and/or circular tubing such as used on chair legs, bed posts, table legs, etc.

FIG. 4 is a representative illustration showing a method of use of the portable video media device holder 100. The illustration shows how the anchor clip portion 400 can be attached to surfaces such as a table 80. As shown in FIG. 4, adjustable clamp 300 holds iPhone 90 securely so as to allow for user 70 to enjoy hands free viewing. User 70 can easily adjust viewing distance D and angle B by adjusting the curvature of flexible shaft 200, ball joint 308 and even clipping on a different surface and/or combination thereof. Moreover, adjustable clamp 300 can hold on to a variety of objects such a cell phone, a calculator, a light, video iPods, or any item that can be supported by the holding strength of the flexible shaft 200. With the degree of freedom offered by the present invention 100, user 70 can truly enjoy hands free, close to one's face, comfortable viewing of iPhone in virtually any location.

Anchor clamp portion 400 allows user 70 to attach portable video media device holder 100 to a wide variety of surfaces or objects to allow ease of use. Besides the table 80 in the illustration in FIG. 4, the portable video media device holder 100 also allows users to attach their iPhone device 90 to surfaces and objects such as but not limited to flat screen computer monitors, bed posts, lamps, airplane tray tables, train and bus poles, treadmill handles, desks, car visors, etc. The portable video media device holder 100 also allows for a variety of uses outdoors, such as to attach to poles or surfaces on boats, branches of trees when camping or picnicking, to the frame of user's backpack when hiking, to bicycle handlebars, helmets, etc. The portable video media device holder 100 can be attached to any surface which can fit in between the jaws of the anchor clamp 400.

With the bendable flexible shaft 200, the present invention 100 is flexible enough to be folded and reduced in size and made portable for traveling.

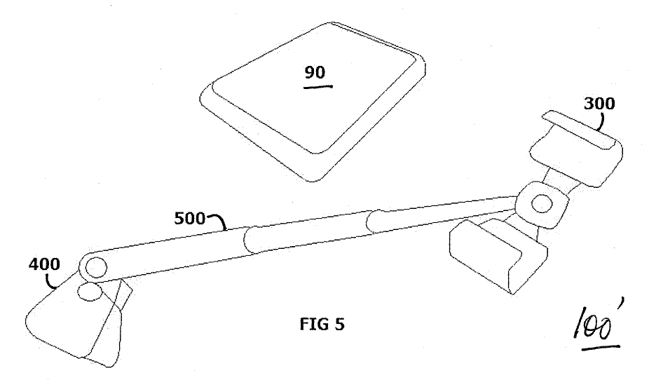

FIG. 5 is a representative isometric view of an alternative embodiment of telescoping extender 500 of the portable video media device holder 100′ of the present invention. As shown in FIG. 5, a telescope extender 500 replaces the flexible shaft portion. In one embodiment, the telescope extender 500 is coupled rigidly on anchor clamp portion 400 at one end and a tilt-able version of adjustable clamp 300 at the other end. The telescoping extender portion 500 enhances the portability of the portable video media device holder 100′ as it can be shortened easily.

It will be understood that telescoping extender portion 500 can include flexible, elastic components. Thus, the telescoping extender portion 500 can also have twisting, bending and curvature degrees of freedom. Providing the present invention 100′ with a telescoping extender portion 500 enhances functionality and interoperability with a range of media device players 90.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A portable video media player holding and displaying device to provide an adjustable base, reduced viewing distance and flexible orientation of portable video devices such as an iPhone, the portable video media player holding and displaying device comprising:
an adjustable, internal spring-operated clamp portion having two gripping arms, the two gripping arms formed integrally with the clamp portion, the two gripping arms adjustably spaced to provide a secure grip onto a portable video media device such as an iPhone when in place, the two gripping arms easily moving in opposite direction when inserting and removing the portable video media device such as the iPhone, the adjustable, internal spring-operated clamp portion further having two partner jaw portions, one jaw portion inserted partly inside the other jaw portion, the jaw portions further having a groove to house a compression spring, the two jaw portions locked in position by a locking plate;
an adjustable spring clip portion having a plurality of gripping plates, the gripping plates urged towards each other by the spring; and
an elongated, flexible shaft portion having two ends, the distal end attached mechanically to the clamp portion, the postal end attached mechanically to the spring clip portion.

2. The portable video media player holding and displaying device of claim 1 in which the inside surface of the gripping arms is curved.

3. The portable video media player holding and displaying device of claim 1 in which the inside surface of the gripping arms is covered with a non-slip pad.

4. The portable video media player holding and displaying device of claim 3 in which the non-slip pad is made of silicon rubber.

5. The portable video media player holding and displaying device of claim 1 in which the flexible shaft is made of soft aluminum surface.

6. The portable video media player holding and displaying device of claim 5 in which the flexible shaft is encased by a tubular protective shield.

7. The portable video media player holding and displaying device of claim 6 in which the tubular protective shield is made of materials selected from the group consisting of silicon rubber, plastic, resin and leather.

8. The portable video media player holding and displaying device of claim 1 in which the adjustable clamp portion holds any iPod with video capability.

9. The portable video media player holding and displaying device of claim 1 in which the adjustable clamp portion holds a Zune™ media player, a PSP™ device, a Treo® phone, or a BlackBerry® phone.

10. The portable video media player holding and displaying device of claim 1 in which the shaft is in the form of extendable telescopic arm.

11. The portable video media player holding and displaying device of claim 10 in which the flexible telescopic arm is made of materials selected from the group consisting of metal and plastic.

12. The portable video media player holding and displaying device of claim 1 in which the shaft is in the form of a chain of bendable links.

13. The portable video media player holding and displaying device of claim 12 in which the links are made of materials selected from the group consisting of metal and plastic.

14. The portable video media player holding and displaying device of claim 1 in which the clamp portion further having a ball and socket joint attached mechanically on the back

15. The portable video media player holding and displaying device of claim 1 in which the base is in a form of a weighted bottom.

16. The portable video media player holding and displaying device of claim 1 in which the spring clip portion having a plurality of gripping plates, the bottom gripping plate attached by a hinge to the tip of the bottom clipping end of the spring clip portion.

17. A method for handsfree operation and viewing of portable video players such as the iPhone, the method comprising the following steps:
Obtaining a portable video media player holding and displaying device comprising an adjustable, internal spring-operated clamp portion having two gripping arms, two partner jaw portions, an adjustable spring clip portion having a plurality of gripping plates, the gripping plates urged towards each other by the spring and an elongated, flexible shaft portion having two ends, the distal end attached mechanically to the clamp portion, the postal end attached mechanically to the spring clip portion;
Affixing a portable video player such as the iPhone within the grip of the two partner jaw portions of the portable video media player holding and displaying device;
Making sure the monitor of the portable video player such as the iPhone is facing outward;
Selecting a desirable surface or fixture providing optimum viewing distance;
Attaching the portable video media player holding and displaying device to the surface or fixture using the adjustable spring clip portion; and
Adjusting the curvature of the flexible shaft portion to attain optimal viewing distance and angle.
